(19) United States
(12) Patent Application Publication
(10) Pub. No.: US 2009/0174946 A1
(43) Pub. Date: Jul. 9, 2009

(54) CUSTOMIZABLE HEAD MOUNTED DISPLAY

(76) Inventors: Roni Raviv, Nes Ziona (IL); Liran Ganor, Even-Yehuda (IL)

Correspondence Address: David Klein;DEKEL PATENT LTD., Beit HaRof'im, 18 Menuha VeNahala Street, Room 27, REHOVOT, IL

(21) Appl. No.: 12/348,919

(22) Filed: Jan. 6, 2009

Related U.S. Application Data
(60) Provisional application No. 61/019,338, filed on Jan. 7, 2008.

(51) Int. Cl. G02B 27/01

(52) U.S. Cl. 359/632; 359/630

(57) ABSTRACT

A HMD including a display substrate and an optics module disposed in a housing for generating an image and projecting a beam of the image on the display substrate, wherein a position of the beam from the optics module with respect to the display substrate is adjustable so as to adjust a virtual distance at which the image is seen.

### FIELD OF THE INVENTION

The present invention relates generally to head mounted displays, and particularly to a head mounted display with adjustable features, such as but not limited to, focus, color, lenses, and viewing image distance.

### BACKGROUND OF THE INVENTION

A head mounted display system is a real display system that is mounted on a user's head and projects a virtual image for one or both eyes. Because a head mounted display does not restrict a user's movement, it has many practical uses, such as for viewing time and date, traffic and stock reports, or even e-mails. However, creating head mounted displays typically involves tradeoffs between size, weight, field of view and compact design, vision preference and others.

### SUMMARY OF THE INVENTION

The present invention seeks to provide a head mounted display (HMD) with adjustable viewing distance, as is described more in detail hereinbelow. In accordance with an embodiment of the present invention, the HMD can set the image at any desired virtual distance. e.g., from 20 cm to infinity, and hence place the image at a convenient viewing position which eliminates the need for refocus and delays associated therewith.

There is thus provided in accordance with an embodiment of the present invention a HMD including a display substrate, and an optics module, disposed in a housing, for generating an image and projecting a beam of the image on the display substrate, wherein a position of the beam from the optics module with respect to the display substrate is adjustable so as to adjust a virtual distance at which the image is seen. For example, the optics module is movably mounted in the housing, such that a position of the optics module with respect to the display substrate is adjustable. The virtual distance at which the image is seen may be in a range from 20 cm to infinity.

In accordance with an embodiment of the present invention the display substrate is pivotally mounted to the housing by means of a hinge. The hinge may permit adjusting an angular rotation of the display substrate to any desired angle or to a predetermined angle. The display substrate may be pivotally mounted to an extension arm of the housing. The rotational orientation of the display substrate with respect to the housing is adjustable to move displayed information to different areas of a field of view.

Further in accordance with an embodiment of the present invention the display substrate is detachably mounted to the housing or hinge. This feature provides additional safety and allows for interchanging the substrates for different functionalities or esthetics.

There is also provided in accordance with an embodiment of the present invention a method including providing a HMD that includes a display substrate, and an optics module, disposed in a housing, for generating an image and projecting a beam of the image on the display substrate and adjusting a distance of the beam from the optics module to the display substrate so as to adjust a virtual distance at which the image is seen.

### BRIEF DESCRIPTION OF THE DRAWINGS

The present invention will be understood and appreciated more fully from the following detailed description taken in conjunction with the drawings in which:

FIG. 1 is a simplified pictorial illustration of a head mounted display (HMD), constructed and operative in accordance with an embodiment of the present invention, and mounted on a visor or goggles;

FIG. 2 is a simplified pictorial illustration of the HMD of FIG. 1 mounted on eyeglasses or sunglasses, in accordance with an embodiment of the present invention;

FIG. 3 is a simplified pictorial illustration of the HMD of FIG. 1 mounted on a diving mask, in accordance with an embodiment of the present invention;

FIGS. 4A and 4B are simplified pictorial illustrations of the HMD of FIG. 1 mounted on a bicycle helmet, respectively folded up (away from a user's view) and folded down (for viewing by the user), in accordance with an embodiment of the present invention;

FIG. 5 is a simplified schematic illustration of the optical elements of the HMD and the relation of the projected image to the user's eye, in accordance with an embodiment of the present invention;

FIG. 6 is a simplified schematic illustration of a tri-chromatic optical projection system for the HMD, in accordance with an embodiment of the present invention;

FIG. 7 is a graphical illustration of transparency vs. wavelength for different colors;

FIG. 8 is a simplified pictorial illustration of different detachable display substrates for the HMD of FIG. 1, in accordance with an embodiment of the present invention;

FIGS. 9A and 9B are simplified pictorial illustrations of a detachable display substrate for the HMD of FIG. 1, respectively before and after attachment to a mounting provision of the HMD, in accordance with an embodiment of the present invention;

FIGS. 10A and 10B are simplified schematic illustrations, of the angular relation of a prior art HMD and the HMD of FIG. 1, respectively, with respect to the user's eye;

FIGS. 11A and 11B are simplified pictorial illustrations of adjusting the imaginary distance depth of the HMD of FIG. 1, in accordance with an embodiment of the present invention; and

FIGS. 12A and 12B are simplified pictorial illustrations of adjusting the display substrate of the HMD so as to move the displayed information to different areas of the field of view (FOV), in accordance with an embodiment of the present invention.

### DETAILED DESCRIPTION OF EMBODIMENTS

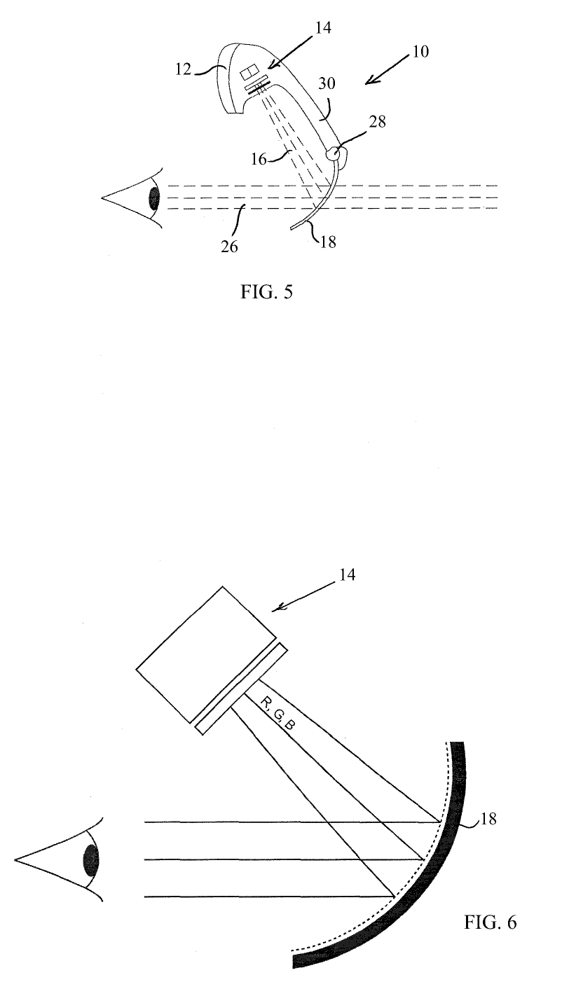

Reference is now made to FIG. 5, which illustrates a HMD 10, constructed and operative in accordance with a non-limiting embodiment of the present invention.

HMD 10 includes a housing 12 in which is disposed an optics module 14. Optics module 14 may include a computer-generated imagery (CGI) system and suitable optical elements (lenses, mirrors, filters, LCD, OLED, etc.) for generating images and projecting a beam 16 of the images on a display substrate (also called display screen) 18. Examples and applications of systems are given below. It is noted that optics module 14 may include the display screen; the module has the optical power capacity to generate the virtual image.

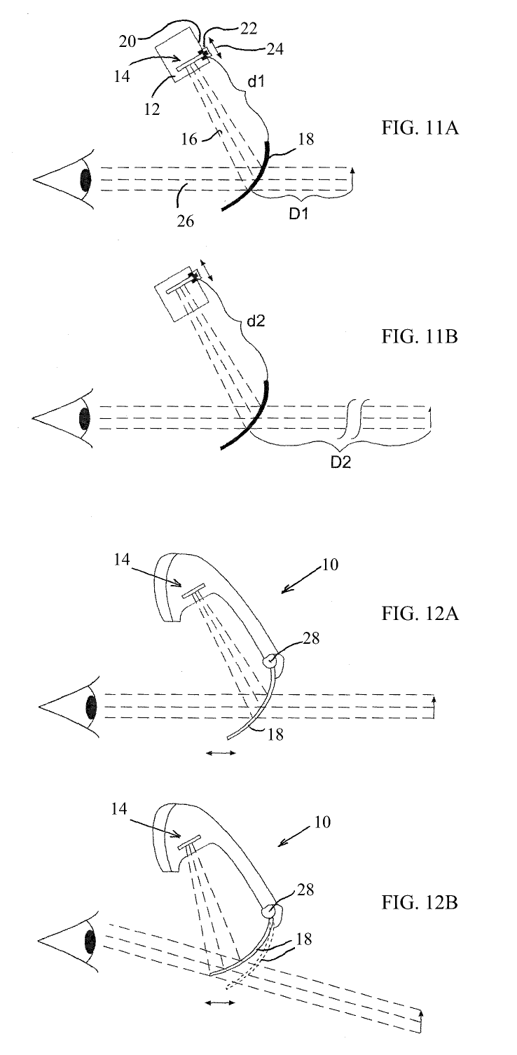

Reference is made additionally to FIGS. 11A-11B. Optics module 14 is movably mounted in housing 12, such that the focal distance of the beam 16 to display substrate 18 may be adjusted by the user. In a preferred embodiment, the focal distance of a lens of optics module 14 is fixed, and the image source is moved so as to change the distance of the imaginary image as viewed by the user. For example, optics module 14 may be mounted on a track 20 formed in housing 12 and a knob 22 may be grasped by the user to move optics module 14 in the direction of arrows 24. In FIG. 11A, a reference distance d1 is the distance between optics module 14 and a reference point on display substrate 18. Corresponding to this setting, the user sees the displayed images along an optical path 26 at a certain virtual distance. D1 denotes a reference distance from some reference point on display substrate 18 to where the images are seen. In FIG. 11B, the user has moved optics module 14, and there is now a new reference distance d2 corresponding to a different (longer) virtual distance with a new (longer) distance D2.

Accordingly, HMD 10 provides the capability for the user to set the image at any desired virtual distance, such as from 20 cm to infinity. HMD 10 places the image at a convenient viewing position and eliminates the need for refocus and the delay associated with it.

It is noted that “infinity virtual distance” is the distance at which the viewing eye sees the object with relaxed focus. This distance may be 20 m or more.

Reference is now made to FIG. 5 and to FIGS. 12A-12B. In one embodiment, display substrate 18 is pivotally mounted to housing 12 by means of a hinge 28. Hinge 28 may be a friction hinge that permits adjusting the angular rotation of display substrate 18 to any desired angle. Alternatively, hinge 28 may have detents or stops that permit adjusting the angular rotation of display substrate 18 to one of many predetermined angles (e.g., audible clicks may be heard when rotating through the range of predetermined angles). In the embodiment illustrated in FIG. 5, display substrate 18 is pivotally mounted to an extension arm 30 of housing 12. (In the embodiment illustrated in FIGS. 4A-4B, display substrate 18 is pivotally mounted on housing 12 and there is no extension arm.) Because display substrate 18 is pivotally mounted to housing 12, the display substrate 18 can be folded away to instantaneously clear the field of view. As seen in FIGS. 12A-12B, the rotational orientation of display substrate 18 of HMD 10 can be adjusted to move the displayed information to different areas of the field of view or completely outside the FOV.

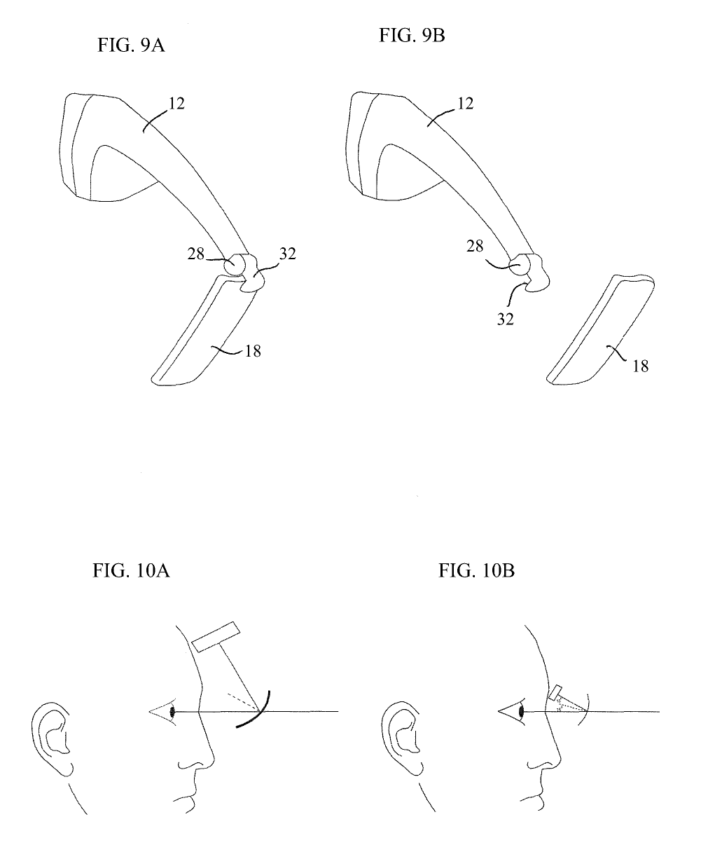

As seen in FIGS. 9A and 9B, the display substrate 18 may be detachably mounted to hinge 28, such as by clicking or snap-fitting onto a mounting clasp 32 of hinge 28. This has the additional safety feature of protecting the viewer from foreign objects entering the eye and allows for interchanging the substrates for different functionalities or esthetics.

Housing 12 may be constructed, without limitation, of a rigid plastic. The display substrate 18 may be constructed, without limitation, of optical-grade injected-molded polycarbonate, which is very suitable for mass production. Thus display substrate 18 may be a low-cost, mass-produced, injected-molded reflective lens, which may be aspheric for low image distortion and miniaturization. As is well known in the art, display substrate 18 may be transparent, semi-transparent, or opaque, and may comprise a monochromatic transmissive substrate or may be coated with a thin film coating, such as a dichroic coating, on a front or rear surface thereof. Multilayer thin film coatings may be used for optimal contrast and brightness on injected molded polycarbonate lenses in varying ambient light conditions.

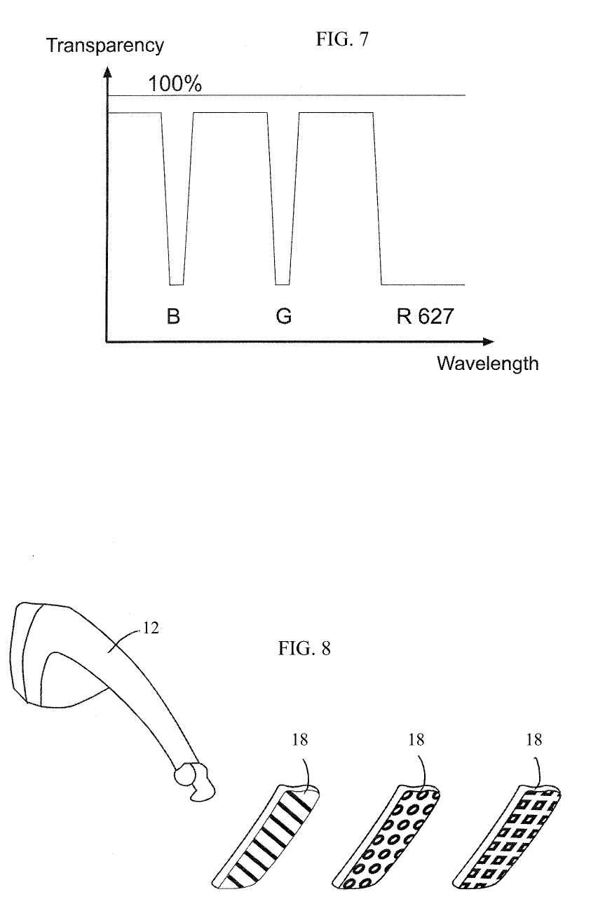

Referring to FIG. 6, it is seen that HMD 10 may be provided with two or three color optics (such as red and green, or red, green and blue). As seen in FIG. 8, HMD 10 may be provided with different detachable display substrates 18 having, for example, different colors or lens characteristics (smooth, Fresnel, holographic and others). FIG. 7 is a graphical illustration of transparency vs. wavelength for different colors.

Accordingly, the HMD 10 may be constructed as a monochromic and monocular HMD with interchangeable display substrates 18 for displaying images in different colors while maintaining high transparency. HMD 10 may be constructed as an augmented monochromatic, high contrast outdoor head mounted display with a very small form factor, and having power efficient illumination and back lighting technology. HMD 10 may have an overall size of less than 25 mm.

Reference is now made to FIGS. 10A and 10B, which respectively compare the angular relation of a prior art HMD and HMD 10 of the present invention. The prior art HMD has an angle of incidence (defined as the half-angle between the optics module and the viewer's line of sight) of 30 or more. In contrast, HMD 10 has smaller angles of incidence in the range of 10°-15° or less.

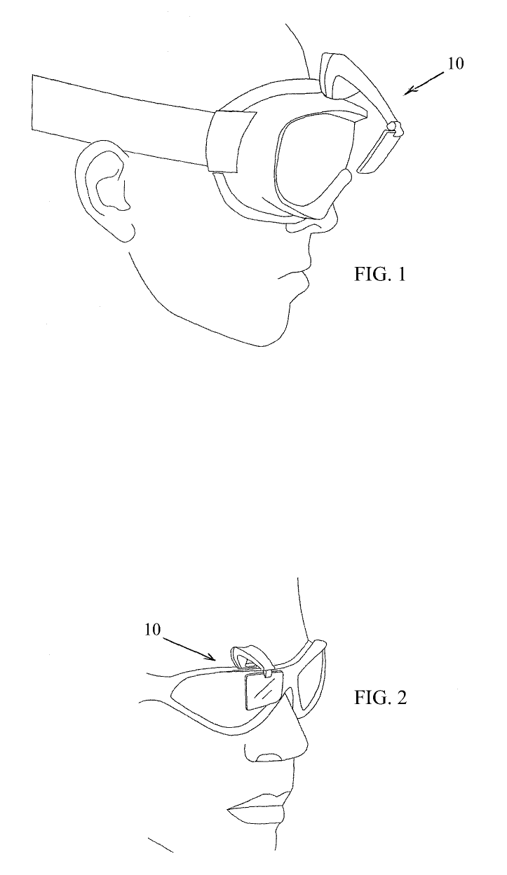

FIGS. 1-4B show different applications of the HMD 10 of the present invention. For example, for cycling (FIGS. 4A-4B), a visor-based HMD system may be provided. This system can provide important real time data to the cyclist such as elapsed time and distance, vital biometric information such as heart and respiration rate and optional GPS information. While cycling, HMD 10 provides a safe and ergonomic method of adjusting the overlaid information image at a preferred focal distance and position.

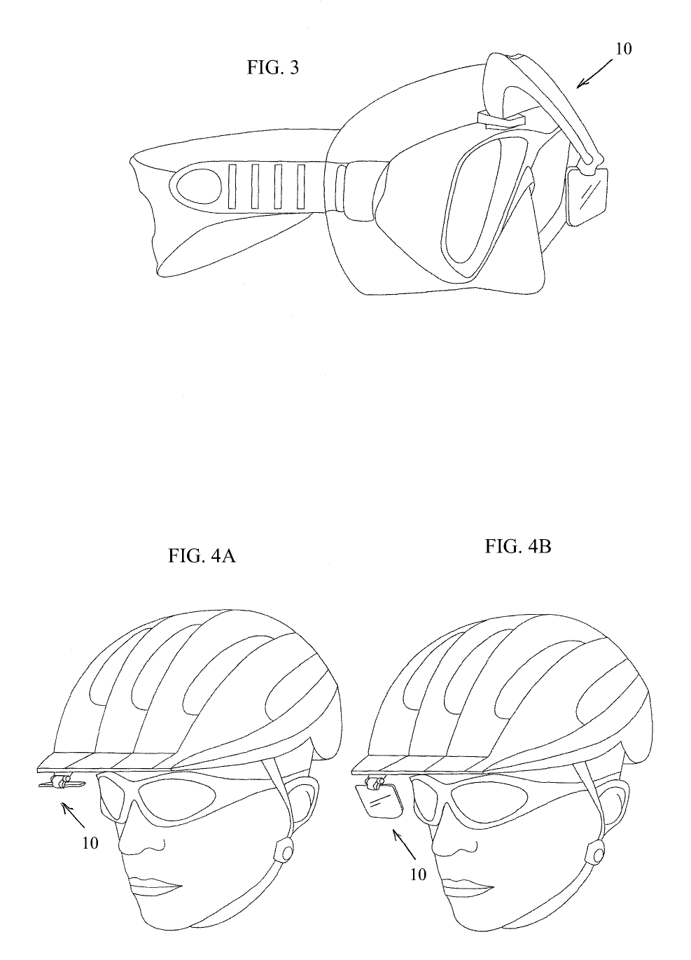

FIG. 3 shows HMD 10 as an add-on HMD clip to a diving mask for scuba and the like. HMD 10 can display full computed decompression dive information, digital compass and air usage information. HMD 10 provides a significant safety improvement by displaying the vital information real-time in the diver's field of view. It is noted that all prior art scuba HMDs are designed inside the mask. In contrast, in the present invention, the HMD is external and there is no need to modify the mask or buy a customized mask.

FIG. 1 shows HMD 10 as an add-on HMD clip to goggles, such as snow goggles. Downhill skiers, snowboarders and cross country athletes can receive information, such as environmental, navigational, safety information. Personal skiing or snowboarding performance information can be displayed by HMD 10. FIG. 2 shows HMD 10 as an add-on HMD clip to eyeglasses or sunglasses.

The information displayable and the applications are many and varied. As described above, in one embodiment of the invention, HMD 10 is an augmented reality HMD. HMD 10 can provide the user with quicker access to information while the user simultaneously and safely performs uninterrupted activities. For example, in the mobile and entertainment fields, the small size HMD 10 enables the user to receive important online and offline messages and data while performing other tasks in a non-intrusive manner. HMD 10 displays the processed information in high contrast on the inner portion of the see-through display near the center of the viewer's field of vision. The user has an unobstructed view while the information is overlaid (augmented) at a preferred and selected distance focus which eliminates the delay of focus and attention adjustment.

HMD 10 may be incorporated in mobile eyewear. The information displayed in the small see-through transparent display visor originates in a mobile device and is transmitted to the optics module via Bluetooth or other wireless connection. The mobile device eyewear viewing experience is completely see-through, providing the wearers with visual information as an augmented overlay without losing awareness of the surroundings.

One application in the mobile communication field is that of “hands free” mobile communication devices. HMD 10 allows the user to see visual data while performing other activities with no interruption of current activity. In a hands free mobile application, the user sees the phone's information, user menus or other selected data in an augmented see-through manner. Displayed data may include, without limitation, incoming call caller ID and contact names, which appear in the field of view and enable the user to recognize and decide whether to accept or reject an incoming call. Alerts and incoming messages like SMS, e-mail headers and full text can be displayed according to the user's preference. The navigation for these applications may be implemented by voice recognition or alternatively by a miniaturized remote controller, such as a hand manipulated control ring.

In the entertainment field, mobile applications (e.g., MP3 music playing devices) can transmit song information (e.g., the name of the song, singer and songwriter) to the display as well as the words of the song synchronized with the actual melody being played. The ability to receive real-time data on a virtual large screen in the augmented reality manner opens up possibilities for different games in which the user is an active participant.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A head mounted display (HMD) comprising:
a display substrate; and
an optics module, disposed in a housing, for generating an image and projecting a beam of said image on said display substrate, wherein a position of said beam with respect to said optics module to said display substrate is adjustable so as to adjust a virtual distance at which said image is seen.

2. The HMD according to claim 1, wherein said optics module is movably mounted in said housing, such that a distance of said optics module to said display substrate is adjustable.

3. The HMD according to claim 1, wherein said virtual distance at which said image is seen is in a range from 20 cm to infinity.

4. The HMD according to claim 1, wherein said display substrate is pivotally mounted to said housing by means of a hinge.

5. The HMD according to claim 4, wherein said hinge permits adjusting an angular rotation of said display substrate to any desired angle.

6. The HMD according to claim 4, wherein said hinge permits adjusting an angular rotation of said display substrate to a predetermined angle.

7. The HMD according to claim 1, wherein said display substrate is pivotally mounted to an extension arm of said housing.

8. The HMD according to claim 1, wherein said display substrate is pivotally mounted to said housing, and a rotational orientation of said display substrate with respect to said housing is adjustable to move displayed information to different areas of a field of view.

9. The HMD according to claim 1, wherein said display substrate is detachably mounted to said housing.

10. The HMD according to claim 4, wherein said display substrate is detachably mounted to said hinge.

11. The HMD according to claim 1, comprising a plurality of display substrates, each of said display substrates being detachably mountable to said housing, wherein said display substrates have different colors or lens characteristics.

12. The HMD according to claim 1, further comprising a diving mask, wherein said HMD is externally mounted to said diving mask and is arranged to display information in real-time in a field of view of a wearer of said diving mask.

13. A method comprising:
providing a HMD that comprises a display substrate, and an optics module, disposed in a housing, for generating a video image and projecting a beam of said image on said display substrate; and
adjusting a distance of said beam from said optics module to said display substrate so as to adjust a virtual distance at which said image is seen.

14. The method according to claim 13, wherein said display substrate is pivotally mounted to said housing, and further comprising adjusting a rotational orientation of said display substrate with respect to said housing so as to move displayed information to different areas of a field of view.
